(19) United States
(12) Patent Application Publication
(10) Pub. No.: US 2013/0333666 A1
(43) Pub. Date: Dec. 19, 2013

(54) INTERNAL COMBUSTION ENGINE

(71) Applicants: Albert Ebner, Backnang (DE); Jens Schittenhelm, Herrenberg (DE); Dirk Schneider, Calw-Alzenberg (DE); Helge Wollenhaupt, Waiblingen (DE); Klaus Wunderlich, Waiblingen (DE)

(72) Inventors: Albert Ebner, Backnang (DE); Jens Schittenhelm, Herrenberg (DE); Dirk Schneider, Calw-Alzenberg (DE); Helge Wollenhaupt, Waiblingen (DE); Klaus Wunderlich, Waiblingen (DE)

(73) Assignee: DAIMLER AG, Stuttgert (DE)

(21) Appl. No.: 13/757,805

(22) Filed: Feb. 3, 2013

(30) Foreign Application Priority Data
Aug. 7, 2010 (DE) 10 2010 034 227.0

(51) Int. Cl. F02M 69/00

(52) U.S. Cl. CPC F02M 69/00
USPC 123/445

(57) ABSTRACT

In an internal combustion engine, in particular for a motor car, having a fuel supply for liquid fuel, in particular gasoline, and a fuel supply for gaseous fuel, in particular natural gas, at least one heat exchanger is provided between the two fuel supplies, by means of which a heat exchange is facilitated between the gaseous and the liquid fuels.

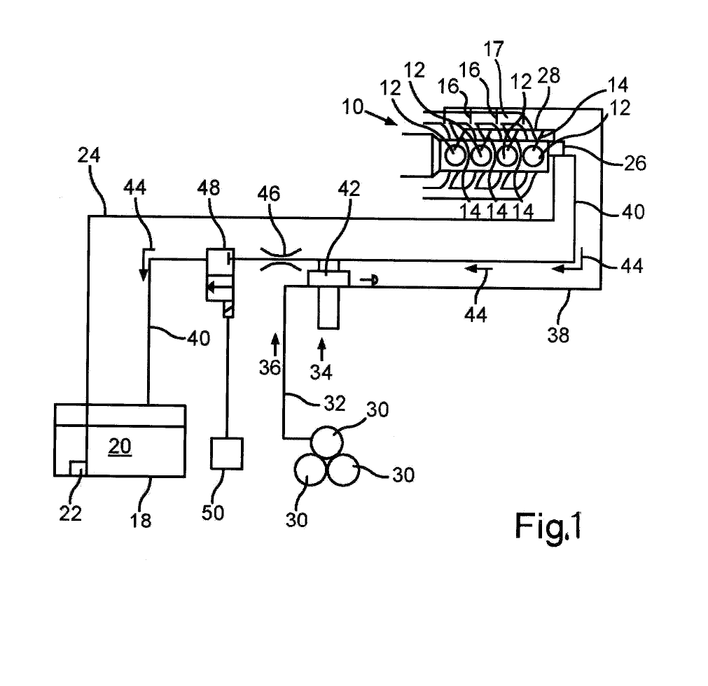

This is a Continuation-In-Part application of pending international patent application PCT/EP2011/003765 filed Jul. 27, 2011 and claiming the priority of German patent application 10 2010 034 227.0 filed Jul. 27, 2011.

### BACKGROUND OF THE INVENTION

The invention relates to an internal combustion engine, in particular for a motor car with a liquid and gaseous fuel supply.

DE 10 2006 054 463 A1 discloses a method for operating a bivalent, spark ignited internal combustion engine which can be operated with liquid and gaseous fuel, for which at least one injection nozzle for gasoline and at least one gaseous fuel injection nozzle are provided for each cylinder. It is thereby provided that both liquid and gaseous fuel are injected simultaneously in a selected operating range of the internal combustion engine and, otherwise, the operation of the internal combustion engine is realized with liquid or gaseous fuel.

It is the principal object of the present invention to provide an internal combustion engine of the type initially mentioned which can be operated in particularly efficient manner.

### SUMMARY OF THE INVENTION

The internal combustion engine according to the invention can for example be operated in one operating state exclusively with the gaseous fuel and in another operating state exclusively with the liquid fuel. It is also possible for an operating state to be provided, in which the internal combustion engine is operated both with the liquid fuel and with the gaseous fuel. In these operating states, the gaseous fuel and/or the liquid fuel is/are introduced in at least one combustion chamber, in particular a cylinder, of the internal combustion engine and combusted. In order to realize such operating states of the internal combustion engine, the motor car comprises respective storage units, in particular tanks. The liquid fuel is stored in one of the storage units and the gaseous fuel in the other storage unit.

The heat exchange, between the gaseous and the liquid fuel facilitated by the heat exchanger permits an adjustment of the respective temperatures of the fuels. In other words, desired temperatures of the fuels can be set which facilitate an efficient operation of the internal combustion engine, as the fuels then have advantageous properties. This adjustment of the desired temperature is possible without additional resources, in particular without additional energy or components. This means that the number of parts, the weight, the construction space requirement and the costs of the internal combustion engine according to the invention are kept low. This aspect also has a positive effect upon a particularly efficient operation of the internal combustion engine as no additional energy must be expended to regulate additional components and/or to adjust the desired and advantageous temperatures of the fuels.

According to an advantageous embodiment of the invention the liquid fuel can be cooled by means of the heat exchanger due to the heat exchange. As a result, evaporation of volatile parts of the liquid fuel is avoided or at least reduced. If the liquid fuel evaporates, collection of the evaporated parts is required in order to comply with emission limits, whereby this can be achieved for example by at least one filter, in particular a carbon filter and in particular an active carbon filter. Such a filter can retain the evaporated parts until it reaches a so-called saturation state, from which it cannot collect any further parts. The filter is then saturated. In order to be able to collect further or more evaporated parts, a so-called regeneration of the filter or a larger volume of the filter is necessary. By avoiding or at least reducing the evaporation of the liquid fuel due to the cooling thereof by the heat exchanger, the number of necessary regenerations and the volume of the filter or a corresponding collection means can be kept low. This is advantageous both for the efficient operation of the internal combustion engine and also for the construction space requirement thereof. This leads to the avoidance or resolution of package problems, in particular in a space-critical region such as an engine space.

According to an advantageous embodiment of the invention, the heat exchanger is arranged in the flow direction of the gaseous fuel to be supplied to the internal combustion engine downstream or on a pressure control means, in particular a pressure regulator, by means of which the gaseous fuel can be expanded from a first pressure level to a second pressure level which is lower than the first pressure level. If the internal combustion engine is operated for example with gaseous fuel in one operating state, the gaseous fuel of the corresponding storage unit, for example a gas cylinder, can be removed. The gaseous fuel is in a highly compressed state in the corresponding storage unit but is introduced with a comparatively lower pressure into the combustion chamber. By means of the pressure adjusting means, the gaseous fuel pressure can be lowered in terms of its pressure level, resulting in an expansion of the gaseous fuel. Due to the so-called Joule-Thomson effect, the gaseous fuel thereby cools greatly, whereby it has a temperature of for example approximately 70° C. As a result of this very low temperature, the liquid fuel can be cooled particularly well and efficiently due to the heat exchange, so that the liquid fuel has a particularly low temperature.

In order to continue to keep the construction space requirement of the internal combustion engine low, it is advantageous if the heat exchanger is integrated at least in areas into a housing of the pressure adjusting means.

According to a particularly advantageous embodiment of the invention, liquid fuel flowing back to the corresponding storage unit, in particular the tank for the liquid fuel, can be cooled by means of the heat exchanger. It is thereby possible to cool for example not only a liquid fuel flowing through a corresponding line for injection into the engine but also further liquid fuel present in the storage unit or to adjust it to a desired temperature as a result of the heat exchange. A particularly large amount of liquid fuel can thus be cooled or set to the desired temperature. The advantages of adjusting the temperature in this way are beneficial since the inherent, previously described problem of evaporation of the liquid fuel, in particular in the storage unit, is avoided or at least reduced.

If the heat exchanger is arranged in the flow direction of the liquid fuel flowing back to the storage unit, in particular the tank for the liquid fuel, upstream of a pumping unit, in particular a high-pressure pump, in order to pump the liquid fuel to the internal combustion engine, the pumping unit can be adjusted via the liquid fuel to a certain advantageous temperature. If the fuel is cooled due to the heat exchange, the cooled fuel can flow through the pumping unit, whereby the pumping unit itself is also cooled.

If the internal combustion engine for example in the form of a direct injection gasoline engine is operated solely with the gaseous fuel, whereby only gaseous fuel and no liquid fuel or only a small amount of liquid fuel is introduced into the combustion chamber(s), in particular the cylinder(s), in particular directly injected, no liquid fuel or only a very small amount of liquid fuel is conveyed through the pumping unit to the internal combustion engine. This leads to no fuel exchange or only a very small fuel exchange taking place in the storage unit, in particular the tank, which can lead to insufficient cooling of the pumping unit. In order to realize a fuel exchange, it can be provided that, although no fuel or only a very small amount of fuel is required to operate the internal combustion engine, liquid fuel is conveyed from the storage unit, whereby this conveyed fuel can flow, at least partially unused, via a return line back into the storage unit. The pumping unit can thereby be cooled but this leads to a heating of the liquid fuel in the storage unit, whereby the highly volatile parts of the liquid fuel can be vaporized if no other precautions are taken. This can result in a change to the composition of the fuel, which can result in poor cold start properties of the fuel and thus the internal combustion engine.

Due to the fact that the heat exchanger is arranged in the flow direction of the liquid fuel flowing back to the storage unit upstream of the pumping unit and the fuel can thus be cooled upstream of the pumping unit due to the heat exchange, on the one hand, an evaporation of the fuel and thus a change to the composition thereof is avoided or at least reduced. On the other hand the pumping unit can be cooled very efficiently and advantageously as it pumps the cooled fuel from the storage unit. Downstream of the pumping unit, the liquid fuel, which has been heated again due to the cooling of the pumping unit, can in turn be cooled as a result of the heat exchange with the gaseous fuel by means of the heat exchanger. The cooled fuel flows then via the return line back to the storage unit, from which it can be conveyed again by the pumping unit, which is then in turn cooled by the liquid fuel. A cooling circuit for cooling the pumping unit is thus formed, while simultaneously avoiding or at least reducing the evaporation of the fuel. This advantageous cooling circuit is thereby realized without additional or notable energy consumption, which benefits the efficient operation of the internal combustion engine.

A further advantage is that the gaseous fuel can also be brought to a desired and advantageous temperature due to the heat exchange. If the gaseous fuel is heated for example due to the heat exchange, icing over of gas-conveying components, for example due to low temperatures of the gaseous fuel through the expansion of the gaseous fuel can be counteracted.

According to an advantageous embodiment the heat exchanger is connected to a line through which the liquid fuel can flow, in particular a return line to the storage unit for the liquid fuel, and to a line through which the gaseous fuel can flow, in particular a supply line to the internal combustion engine. The temperature of the fuels flowing through the respective lines can thereby be adjusted particularly well, efficiently and according to requirements to a respective, desired temperature so that an efficient operation of the internal combustion engine can be achieved. As already described, the liquid fuel can thereby be cooled for example and icing-over of the components conveying gaseous fuel can be counteracted. All this favors an efficient operation of the internal combustion engine according to the invention.

If the fuel line for the liquid fuel includes a switchable valve unit by which the liquid fuel flow can be blocked. Fluid circulating losses of the pumping unit can be kept low. This reduces the losses of the internal combustion engine, which further benefits the efficient operation of the engine. The valve unit thereby advantageously controls the liquid fuel flow through the line. In addition, a desired temperature level of the pumping unit can thereby be set.

Advantageously the valve unit assigned to the line through which the liquid fuel can flow can be adjusted in dependence upon an operating state of the internal combustion engine and I or in dependence upon a temperature of the pumping unit for conveying the liquid fuel to the internal combustion engine. The valve unit is for example an electromagnetically switchable valve which is integrated in the return line. The valve unit facilitates for example a flow of the liquid fuel through the corresponding line only when gaseous fuel is required or desired the for operation of the internal combustion engine and/or when cooling of the pumping unit is necessary. Based on the temperature of the pumping unit it can be decided whether cooling thereof is necessary or not. This temperature is detected for example by means of a detection unit, in particular a sensor, or modeled by means of a model and calculated using the model, for example by means of a control unit, of the internal combustion engine.

If the internal combustion engine is operated with the liquid fuel, in particular gasoline, circulation of the liquid fuel for cooling thereof can be suppressed by the switchable valve unit. This keeps power consumption, in particular electrical power consumption, low or even avoids it. The energy requirement of the internal combustion engine as a whole and thus its fuel consumption can thus be kept low,

Further advantages, features and details of the invention will become more readily apparent from the following description of a preferred exemplary embodiment thereof with reference to the accompanying drawing. The features and feature combinations mentioned above in the description and the features and feature combinations mentioned below in the description of the figures and/or solely shown in the figures can be used not only in the respectively indicated combination but also in other combinations or alone without going outside of the scope of the invention.

### BRIEF DESCRIPTION OF THE DRAWING

The sole drawing shows an illustration of the principles of an internal combustion engine which can be operated both with gaseous and also with liquid fuel and which comprises a heat exchanger, by means of which a heat exchange between the liquid and gaseous fuel is facilitated.

### DESCRIPTION OF AN EXEMPLARY EMBODIMENT

The FIGURE shows an internal combustion engine 10 with four cylinders 12 which can be operated both with gaseous fuel, in particular natural gas (compressed natural gas), and also with liquid fuel in the form of gasoline. In this connection the internal combustion engine 10 comprises respective injectors 14 assigned to the cylinders 12, by means of which gasoline can be injected directly into the cylinders 12. Furthermore it comprises injectors or injection valves 16, by means of which natural gas can be introduced into an air distributor 17 of the internal combustion engine 10. It is also conceivable for the gaseous fuel to be introduced via respective injectors 16 directly into the cylinders.

The internal combustion engine 10 can have an operating state, in which it is operated exclusively with gasoline. It can also have another operating state, in which it is operated exclusively with natural gas.

If gasoline is required to operate the internal combustion engine 10, the gasoline is conveyed from a gasoline tank 18 by means of a pre-conveying pump 22 via a feed line 24 to a high pressure pump 26. The high pressure pump 26 places the gasoline under very high pressure and conveys it to a fuel distributor unit 28, which is also designated a “rail”, from which it is distributed to the injectors 14 and finally injected into the cylinders 12. Due to the high pressure of the gasoline provided by the high pressure pump 26, it can be injected particularly finely atomized into the cylinders 12, which contributes to a very efficient operation of the internal combustion engine 10.

In order to store and move the natural gas, gas cylinders 30 are provided, in which the natural gas is stored in a compressed state at a pressure of up to 200 bar. If natural gas is required or desired to operate the internal combustion engine 10, the gas is fed in the flow direction of the natural gas according to direction arrow 36 via a gas pipe 32 to a pressure regulator 34, by means of which a pressure is adjusted downstream of the pressure regulator 34. By means of a further gas pipe 38, the natural gas is then supplied to the injectors 16 and injected into the air distributor 17.

If the internal combustion engine 10 is operated for example exclusively with natural gas, for cooling the high pressure pump 26 the pre-conveying pump 22 conveys gasoline to the high pressure pump 26, wherefrom the gasoline then flows back into the tank 18 via a return line 40. The gasoline is thereby heated due to the cooling of the high pressure pump 26, which also leads to a heating of the gasoline 20 in the tank 18. In order to cool the thus heated gasoline and the tank 18, to avoid evaporation of volatile parts of the gasoline 20 and to be able to cool the high pressure pump 26 particularly efficiently, a heat exchanger 42 is integrated into the pressure regulator 34, by means of which a heat exchange between the natural gas flowing through the gas pipes 32 and 38 and the gasoline flowing through the return line 40 is facilitated.

Due to the pressure reduction and the expansion of the natural gas by means of the pressure regulator 34, the natural gas drops due to the so-called Joule-Thomson effect to approximately −70° C., so that the gasoline can be cooled particularly efficiently by means of the natural gas. In the flow direction of the gasoline through the return line 40 according to direction arrows 44, a throttle 46 is provided downstream of the heat exchanger 42, by means of which a through-flow limitation and pressure maintenance in the gasoline circuit are realized. Further downstream of the pressure regulator 34, an electromagnetically switchable valve 48 is integrated into the return line 40, by means of which the return line 40 can be opened in a first position so that the gasoline can flow through the return line 40.

In a second position of the valve 48, the return line 40 can be blocked, so that no gasoline can flow through the return line 40 and a pumping-around of the gasoline through the pre-conveying pump 22 via the high pressure pump 26 and back into the tank 18 is prevented. This keeps the power consumption of the pre-conveying pump 22 low, in particular in the operating state, in which gasoline is required or desired to operate the internal combustion engine 10, as circulation can possibly be blocked. This improves the operational efficiency of the internal combustion engine 10.

The switchable valve 48 is switched by a control unit 50 of the internal combustion engine 10 in dependence upon operating states of the internal combustion engine 10 and in dependence upon the temperature of the high pressure pump 26. A cooling of the high pressure pump 26 is necessary for example when its temperature exceeds a predefined threshold. A circulation of the gasoline 20 by means of the pre-conveying pump 22 from the tank 18, via the high pressure pump 26 and via the return line 40 back into the tank 18 is not required in the operating state, in which gasoline is required for the operation of the internal combustion engine 10, as the high pressure pump 26 is then cooled by the fuel injected into the cylinder 12.

The cooling of the gasoline 20 in the tank reduces or even avoids an evaporation of volatile parts of the gasoline 20 so that a collection means, in particular an active carbon filter, for collecting the volatile parts in order to comply with emission limits, can be kept small in terms of its volume. A frequent regeneration of this collection unit is not necessary either.

What is claimed is:

1. An internal combustion engine (10), having a liquid fuel storage unit (18) for storing supply of liquid fuel, and a gaseous fuel storage unit (30) for storing a fuel, comprising at least one heat exchanger (42) arranged between the fuel supplies, by means of which a heat exchange between the gaseous and the liquid fuel is facilitated for cooling liquid fuel flowing back to the liquid fuel storage unit (18), for cooling the liquid fuel (20) by means of the heat exchanger (42).

2. The internal combustion engine (10) according to claim 1, wherein the heat exchanger (42) is arranged in the flow direction (36) of the gaseous fuel to be supplied to the internal combustion engine (10) downstream or on a pressure regulator (34), by means of which the gaseous fuel can be expanded from a first pressure level to a second low pressure level.

3. The internal combustion engine (10) according to claim 2, wherein
the heat exchanger (42) is integrated at least partially into a housing of the pressure adjusting means (34).

4. The internal combustion engine (10) according to claim 1, wherein
liquid fuel flowing back to the storage unit (18), for the liquid fuel (20) is cooled by means of the heat exchanger (42).

5. The internal combustion engine (10) according to claim 1, wherein
the heat exchanger (42) is arranged in the flow direction (44) of the liquid fuel flowing back to a storage unit (18), for the liquid fuel (20) upstream of a pumping unit (22, 26), in particular a high pressure pump (26) for conveying the liquid fuel to the internal combustion engine (10).

6. The internal combustion engine (10) according to claim 1, wherein
the heat exchanger (42) is connected, to a return line (40), through which the liquid fuel can return to the fuel storage unit (18), and is also connected to a gas supply line (32, 38), through which the gaseous fuel can flow to the internal combustion engine (10).

7. The internal combustion engine (10) according to claim 6, wherein
a switchable valve unit (48) is provided in the fuel return line (40) by means of which valve unit (48) the fuel return line (40) blocked.

8. The internal combustion engine (10) according to claim 7, wherein
the valve unit (48) can be adjustable in dependence upon an operating state of the internal combustion engine (10) and in dependence upon a temperature of a pumping unit (22, 26) for conveying the liquid fuel to the internal combustion engine (10).

9. The internal combustion engine (10) according to claim 1, wherein
the internal combustion engine (10) is a directly injecting internal combustion engine (10), in which the liquid fuel can be directly injected into at least one combustion chamber of the internal combustion engine (10).

10. The internal combustion engine (10) according to claim 1, wherein
the gaseous fuel can be introduced into an air distributor (17) of the internal combustion engine (10).
